(19) United States
(12) Patent Application Publication
(10) Pub. No.: US 2011/0099396 A1
(43) Pub. Date: Apr. 28, 2011

(54) STORAGE APPARATUS

(75) Inventor: Yuichi Sakagami, Kawasaki (JP)

(73) Assignee: FUJITSU LIMITED, Kawasaki-shi (JP)

(21) Appl. No.: 12/908,276

(22) Filed: Oct. 20, 2010

(30) Foreign Application Priority Data
Oct. 23, 2009 (JP) 2009-244726

(51) Int. Cl. G06F 1/26

(52) U.S. Cl. 713/310

(57) ABSTRACT

A storage apparatus includes: a storage medium for storing data; a controller for controlling an access from an upper device to the storage medium through a data line for transmitting data; a detector for detecting a transition of an access signal for requesting access from the upper device through the data line; and a power controller for supplying power to the controller in accordance with a rate of the transition of the access signal detected by the detector.

### CROSS-REFERENCE TO RELATED APPLICATION

This application is based upon and claims the benefit of priority of the prior Japanese Patent Application No. 2009-244726 filed on Oct. 23, 2009, the entire contents of which are incorporated herein by reference.

### FIELD

The embodiments discussed herein are related to a storage apparatus.

### BACKGROUND

It is known as to a system in which a plurality of data processing devices are connected to one another that one of the data processing devices activates another one of the data processing devices. As an exemplary system in which a plurality of data processing devices are connected to one another, there is a storage apparatus including a primary device which controls an access request from the outside and an extended device which controls an access request from the primary device to a storage medium included in the own device connected to each other.

A storage apparatus including a primary device connected with an extended device can be provided with more extended devices so that storage media can be added to the storage apparatus. The extended device is, e.g., connected in series to the primary device. The storage apparatus including the primary device connected with the extended device can be configured in such a way that the primary device can activate the extended device.

In order that the primary device is configured to activate the extended device, an exclusive line for power supply control can be provided between the primary device and the extended device. Further, the extended device can be provided in itself with a controller connected to the primary device and configured to control an access to a storage medium provided in the own device, and the controller can be configured to work all the time and to activate the storage medium on the basis of communication with the primary device. Incidentally, if extended devices are connected in series, one of the extended devices having been activated can activate another one of the extended devices connected downstream, so that the plural extended devices can be successively activated. Japanese Laid-open Patent Publication Nos. 59-37755, 2000-214964 and No. 2003-8592 are examples of related art.

The communication interface between the primary device and the extended device, however, may lack a signal for power supply control in some cases. If the communication interface lacking a signal for power supply control is used, a configuration such that an exclusive line for power supply control is provided between the primary device and the extended device as described above cannot be employed.

Further, according to the configuration such that the extended device is provided in itself with a controller connected to the primary device by means of communication and configured to control an access to a storage medium provided in the own device, and that the controller is configured to work all the time, power consumption required by the controller to work cannot be disregarded.

As described above, there is ordinarily a problem in that a communication interface lacking a signal for power supply control cannot reduce the power consumption enough in a waiting state.

### SUMMARY

According to an aspect of the embodiment, a storage apparatus includes: a storage medium for storing data; a controller for controlling an access from an upper device to the storage medium through a data line for transmitting data; a detector for detecting a transition of an access signal for requesting access from the upper device through the data line; and a power controller for supplying power to the controller in accordance with a rate of the transition of the access signal detected by the detector.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram for illustrating a configuration of a storage apparatus according to a first embodiment;

FIG. 2 is a block diagram for explaining a configuration of a storage apparatus according to a second embodiment;

FIG. 3 is a block diagram for illustrating a configuration of an example to be compared with;

FIG. 4 explains a method for OOB detection by means of observing a voltage level;

FIG. 5 explains a method for OOB detection by means of frequency analysis;

FIG. 6 is a flowchart for explaining a processing operation performed when the extended device is activated;

FIG. 7 explains a waiting state of the extended device;

FIG. 8 explains a state in which the extended device detects an OOB sequence;

FIG. 9 explains a state in which the extended device is in operation; and

FIG. 10 is a sequence diagram for explaining power-on synchronization in the storage apparatus.

### DESCRIPTION OF EMBODIMENTS

Embodiments of a storage apparatus disclosed by the present application will be explained in detail with reference to the drawings below. Incidentally, the embodiments do not limit the scope of the disclosed art.

### First Embodiment

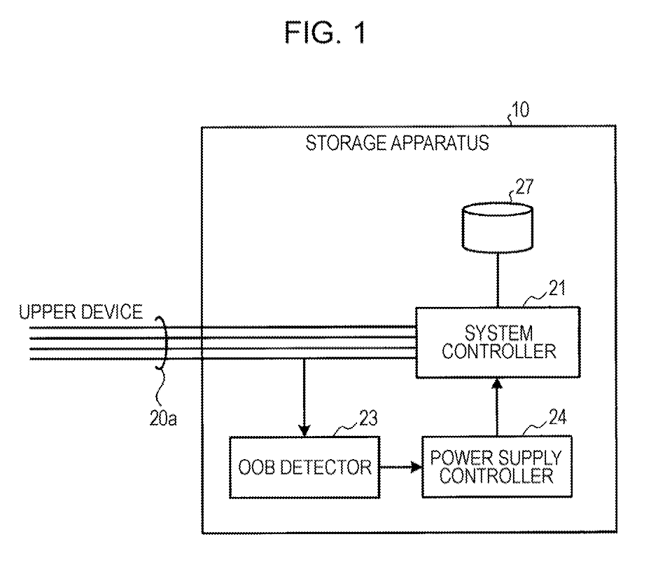

FIG. 1 is a block diagram for illustrating a configuration of a storage apparatus according to a first embodiment. The storage apparatus 10 illustrated in FIG. 1 has an upper communication line 20a via which the storage apparatus 10 is connected to and communicates with an upper device, a system controller 21, an OOB (Out Of Band) detector 23, a power supply controller 24 and a storage medium 27.

The storage medium 27 stores data. The storage medium 27 is a storage medium of any type such as a magnetic disk (HDD: Hard Disk Drive) or a semiconductor recording medium (SSD: Solid State Drive). The upper communication line 20a is a communication line for connecting the storage apparatus 10 to the upper device. The upper device is any device which accesses the storage medium 27 of the storage apparatus 10 via the upper communication line 20a.

The system controller 21 is a controller which controls an access request to the storage medium received via the upper communication line 20a. The system controller 21 is supplied with no power and does not work while the storage apparatus 10 is in a waiting state.

The upper device sets up a communication session by using an OOB (Out Of Band) sequence, etc. before starting an operation for connecting with the storage apparatus 10. The OOB detector 23 observes the upper communication line 20a. Upon detecting a rising edge of a signal used for the OOB sequence, the OOB detector 23 notifies the power supply controller 24 of the detection. The OOB detector 23 is supplied with power even while the storage apparatus 10 is in the waiting state. The OOB detector 23 thereby enables a detecting operation even while the storage apparatus 10 is in the waiting state.

Upon receiving the notice from the OOB detector 23, the power supply controller 24 powers on and activates the system controller 21. As being supplied with power even while the storage apparatus 10 is in the waiting state, the power supply controller 24 enables an operation to wait for a notice coming from the OOB detector 23.

As described above, the storage apparatus according to the first embodiment leaves the system controller 21 not working in the waiting state, detects a rising edge of a signal received from the upper device by means of the OOB detector 23 and activates the system controller 21. The storage apparatus can thereby implement power-on synchronization among the devices while reducing power consumption in the waiting state without using a signal for power supply control.

### Second Embodiment

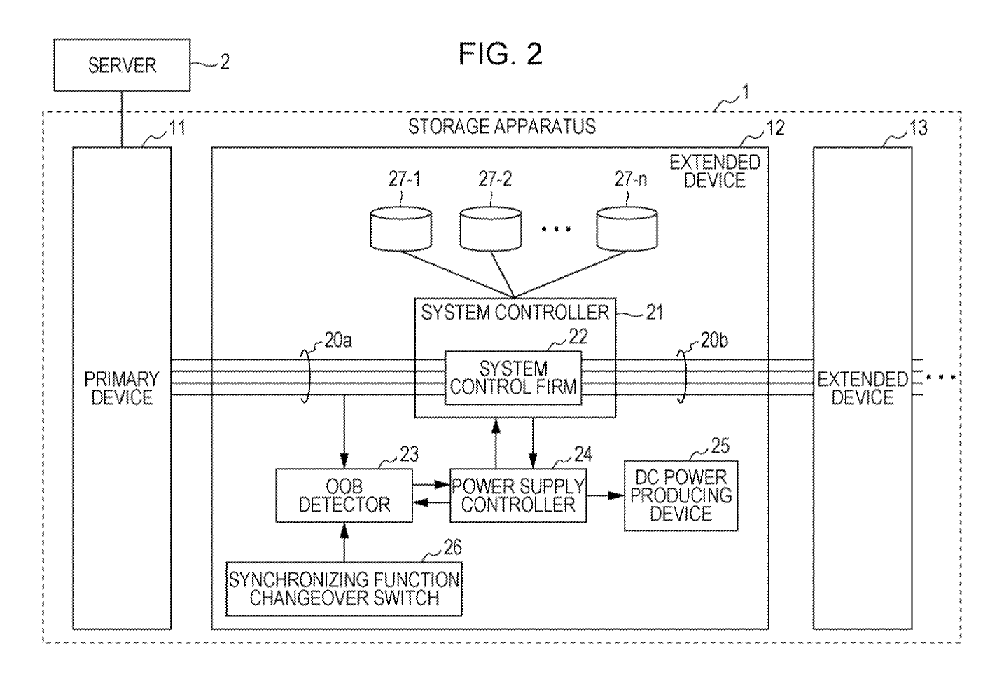

FIG. 2 is a block diagram for explaining a configuration of a storage apparatus according to a second embodiment. As illustrated in FIG. 2, the storage apparatus 1 of the second embodiment has a primary device 11 and extended devices 12 and 13.

The primary device 11 is a control enclosure which controls an access request coming from an external server 2. The extended device 12 is connected with the primary device 11 and is a storage apparatus which controls an access request coming from the primary device to a storage medium provided in the own device, i.e., a disk enclosure, and so is the extended device 13.

The extended devices 12 and 13 are connected in series with the primary device 11. For communication between the primary device 11 and the extended device 12 and between the extended devices 12 and 13, a SAS (Serial Attached SCSI) interface is used. FIG. 2 illustrates a configuration such that the extended devices 12 and 13 are connected in series with the primary device 11, and a plurality of extended devices can further be connected in series at later stages of the extended device 13.

The extended device 12 has an upper communication line 20a, a lower communication line 20b, a system controller 21, an OOB detector 23, a power supply controller 24, a DC power producing device 25, a synchronizing function changeover switch 26 and storage media 27-1 through 27-n.

The system controller (SASexpander) 21 controls data communication among the primary device 11 being an upper device, the storage media 27-1 through 27-n and the extended device 13 being a lower device. The upper communication line 20a which connects the primary device 11 and the system controller 21 has, e.g., four signal lines. The lower communication line 20b which connects the system controller 21 and the extended device 13 similarly has, e.g., four signal lines.

The system controller 21 is a logic device of any kind. The system controller 21 runs a system control firm 22 on the device. The system controller 21 can be, e.g., a device having a CPU (Central Processing Unit) and a memory. The system controller 21 carries out a process for communication with the primary device 11 and with the extended device 13, and a process for accessing the storage media 27-1 through 27-n by running the system control firm 22. Upon being supplied with no power in a waiting state of the extended device 12, the system controller 21 does not work.

The synchronizing function changeover switch 26 holds data indicating whether the extended device 12 is activated synchronously with the primary device 11 having been activated. The synchronizing function changeover switch 26 provides the OOB detector 23 with a signal corresponding to the data being held. If the synchronizing function changeover switch 26 is turned on, the extended device 12 in a waiting state is activated synchronously with the primary device 11 having been activated. After being activated, the extended device 12 is ready to ordinarily operate, i.e., ready to access the storage media 27-1 through 27-n. Meanwhile, if the synchronizing function changeover switch 26 is turned off, the extended device 12 is activated asynchronously with the primary device having been activated upon being directly operated by an operator.

The OOB detector 23 observes the upper communication line 20a. The OOB detector 23 detects a rising edge of a signal used for an OOB sequence. The OOB detector 23 is supplied with power so as to be ready to work even in the waiting state of the extended device 12. If the synchronizing function changeover switch 26 is turned on, the OOB detector 23 detects a rising edge of a signal. If the synchronizing function changeover switch 26 is turned off, the OOB detector 23 does not detect a rising edge of a signal. If the OOB detector 23 does not detect a rising edge of a signal, the OOB detector 23 can be supplied with no power, or can refrain from working while being supplied with power.

If the OOB detector 23 detects a rising edge of a signal, the power supply controller 24 controls the DC power producing device 25 so as to power on and activate the system controller 21 and the storage media 27-1 through 27-n. After activating the system controller 21, the power supply controller 24 makes the OOB detector 23 stop working. As the OOB detector 23 stops working, the storage apparatus can reduce power consumption after starting to work.

The DC power producing device 25 adjusts an output level of voltage provided by an apparatus power supply in response to control directions coming from the power supply controller 24. The DC power producing device 25 supplies the system controller 21 and the storage media 27-1 through 27-n with the adjusted voltage.

As described above, the extended device 12 leaves the system controller 21 not working in the waiting state. Then, upon detecting a rising edge of a signal received from the upper device by means of the OOB detector 23, the extended device 12 activates the system controller 21. The storage apparatus of the embodiment can thereby reduce power consumption without using a signal for power supply control. Further, as explained below, the storage apparatus according to the embodiment can consume less power than a configuration such that the system controller works in the waiting state and detects a signal.

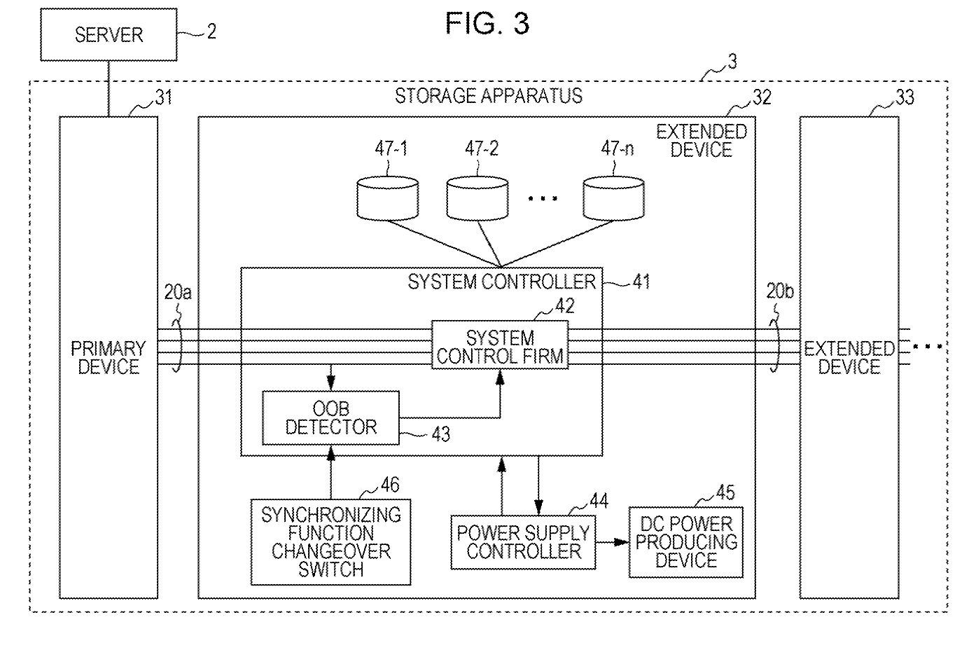

A storage apparatus configured to work the system controller in a waiting state and to detect a signal will be explained below as an example to be compared with. FIG. 3 is a block diagram of the storage apparatus for illustrating the configuration of the example to be compared with. The storage apparatus 3 illustrated in FIG. 3 has a primary device 31 and extended devices 32 and 33. The primary device 31 and the extended devices 32 and 33 are connected in series with one another.

The extended device 32 has an upper communication line 20a, a lower communication line 20b, a system controller 41, a power supply controller 44, a DC power producing device 45, a synchronizing function changeover switch 46 and storage media 47-1 through 47-n.

The system controller 41 communicates with the primary device 31 and the extended device 33 by running a system control firm 42. The system controller 41 processes access to the storage media 47-1 through 47-n. The system controller 41 has an OOB detector 43. The OOB detector 43 is, e.g., a program to be run by the system controller 41.

The system controller 41 is supplied with power and works even in a waiting state of the extended device 32. The system controller 41 observes the upper communication line 20a by means of the OOB detector 43. Upon receiving a signal related to the OOB sequence, the OOB detector 43 activates the system control firm 42.

The synchronizing function changeover switch 46 holds data indicating whether the extended device 32 is activated synchronously with the primary device 31 having been activated. The synchronizing function changeover switch 46 provides the system controller 41 with a signal corresponding to the data being held. If the synchronizing function changeover switch 46 is turned on, the system controller 41 detects a rising edge of the signal by means of the OOB detector 43. If the synchronizing function changeover switch 46 is turned off, the system controller 41 does not detect a rising edge of the signal by means of the OOB detector 43.

Upon receiving instructions from the system controller 41 having detected a signal by means of the OOB detector 43, the power supply controller 44 powers on and activates the storage media 47-1 through 47-n by controlling the DC power producing device 45.

The DC power producing device 45 adjusts an output level of voltage provided by an apparatus power supply in response to control directions coming from the power supply controller 44. The DC power producing device 45 supplies the storage media 47-1 through 47-n with the adjusted voltage.

As described above, the extended device 32 illustrated as the example to be compared with is activated synchronously with the primary device 31. That is, the system controller 41 works even in the waiting state of the extended device 32. Thus, the extended device 32 consumes more power in the waiting state than the extended device 12 illustrated in FIG. 2.

Return to the explanation with reference to FIG. 2. An operation of the OOB detector 23 illustrated in FIG. 2 will be explained as follows. In the OOB sequence, one device transmits to the outside a COMINIT signal for checking whether a device to communicate with is present. Another device having received the COMINIT signal transmits a COMINIT signal back. The two devices having transmitted and received the COMINIT signals to and from each other successively transmits and receives signals such as COMSAS and COMWAKE for identifying a communication type.

The OOB detector 23 detects the COMINIT signal. The COMINIT signal has a voltage signal waveform having six peaks during 106.67 ns. The OOB detector 23 detects the voltage signal waveform of the COMINIT signal. To put it specifically, the OOB detector 23 can observe a voltage level on the upper communication line 20a, or can analyze a frequency of a signal on the upper communication line 20a.

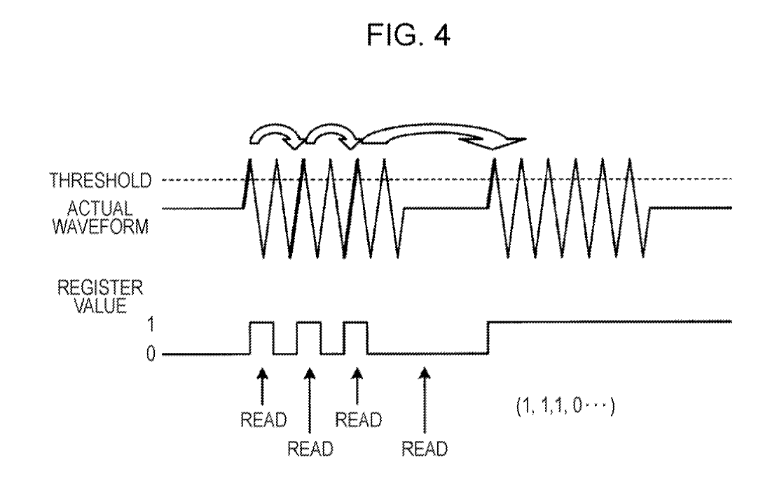

FIG. 4 illustrates a method for OOB detection by means of observing the voltage level. The OOB detector 23 sets “1” to a register if a voltage of a signal propagated on the upper communication line 20a exceeds a threshold, and resets the register if the register is read. As an observation interval is made much shorter than 106.67 ns, the OOB detector 23 can detect the COMINIT signal. FIG. 4 specifically illustrates an exemplary case in which the observation interval of the register is made 30 ns. If the observation interval of the register is 30 ns, the OOB detector 23 identifies success in the OOB detection if values of the register having been read are “1” consecutively three times. Although success in the OOB detection is identified if values of the register having been read are “1” consecutively three times for the example illustrated here, the number of times is not limited to three and any number of times can be suitably chosen.

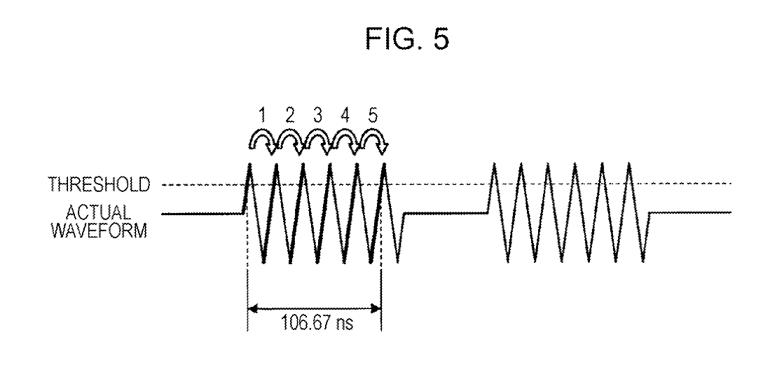

FIG. 5 illustrates a method for OOB detection by means of frequency analysis. The OOB detector 23 performs the OOB detection depending upon how many times rising edges of a voltage signal are detected in a lapse of 106.67 ns after the voltage of the signal propagated on the upper communication line 20a exceeds a threshold. The OOB detector 23 identifies success in the OOB detection if the rising edges of the voltage signal are detected five times in a lapse of 106.67 ns after the voltage of the signal exceeds the threshold. Although the OOB detector 23 identifies success in the OOB detection if the rising edges of the voltage signal are detected five times for the example illustrated here, the number of times is not limited to five and any number of times can be suitably chosen.

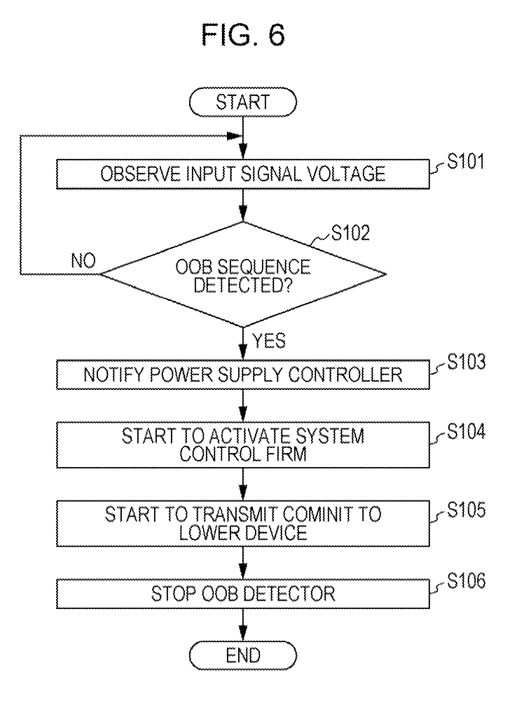

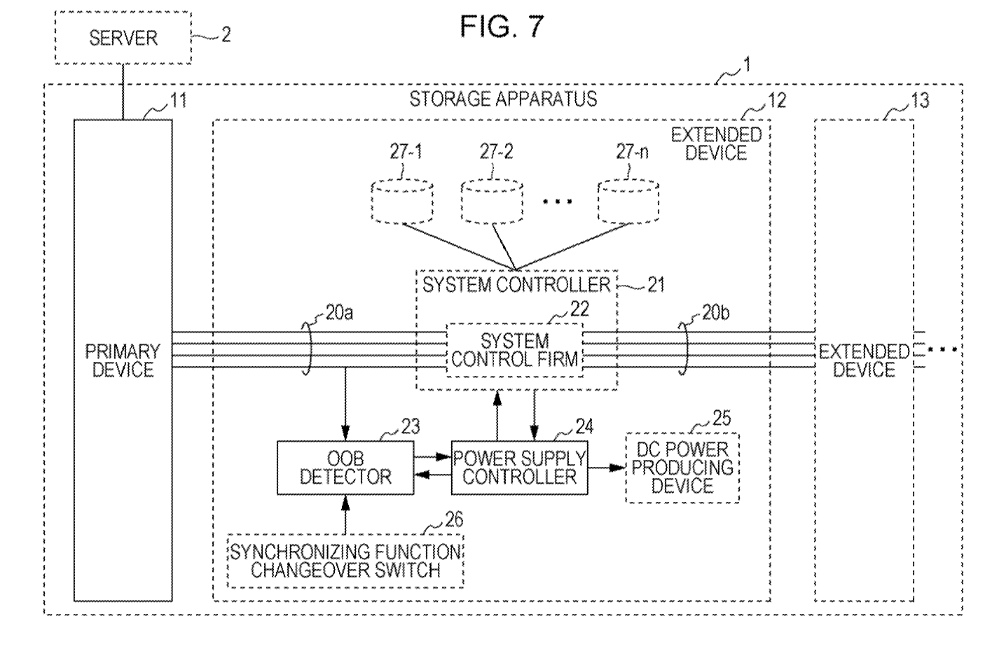

Then, a processing operation performed when the extended device 12 is activated will be explained. FIG. 6 is a flowchart for illustrating the processing operation performed when the extended device 12 is activated. Further, FIGS. 7-9 illustrate a change of the extended device 12 from a waiting state to an operating state.

In the waiting state of the extended device 12, the OOB detector 23 observes voltage of an input signal propagated on the upper communication line 20a (FIG. 6, S101). FIG. 7 explains the waiting state of the extended device 12. In FIG. 7, components being powered on and working are illustrated by solid frames, and components not working are illustrated by dotted frames. In the waiting state of the extended device 12, the OOB detector 23 and the power supply controller 24 are working, and so are neither the system controller 21 nor the storage media 27-1 through 27-n. Further, the primary device 11 has started to work in FIG. 7.

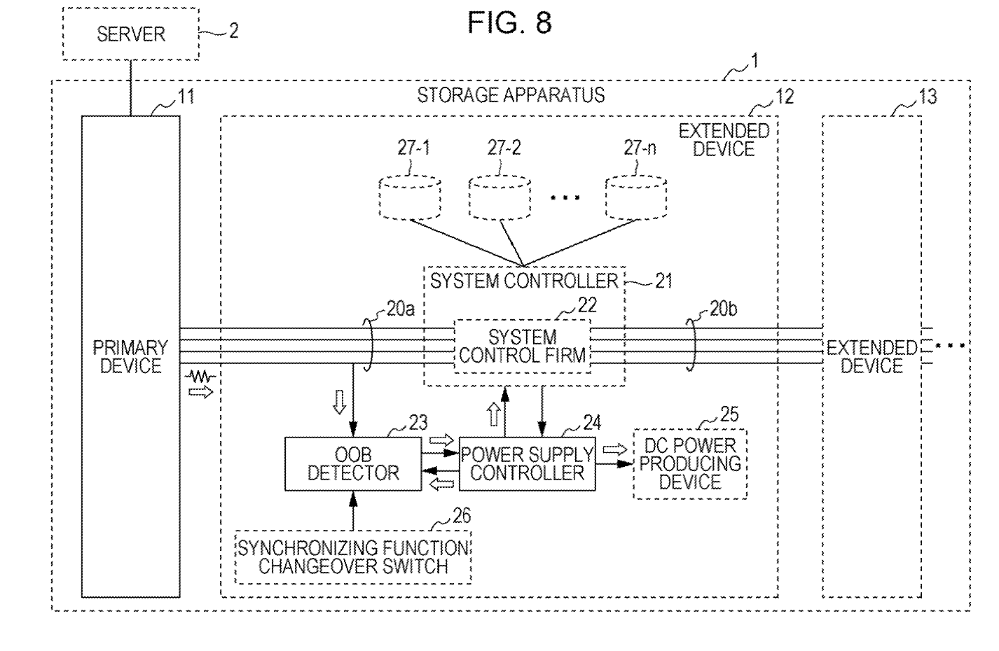

The primary device 11 carries out the OOB sequence upon being activated, and transmits a COMINIT signal to the upper communication line 20a which connects the extended device and the primary device as illustrated in FIG. 8. In FIG. 8, components being powered on and working are illustrated by solid frames, and components not working are illustrated by dotted frames. Upon detecting the COMINIT signal (FIG. 6, S102, Yes), the OOB detector 23 notifies the power supply controller 24 of the detection (FIG. 6, S103).

Upon being notified by the OOB detector 23, the power supply controller 24 powers on the system controller 21, and directs the system controller 21 to activate the system control firm 22. Upon being directed, the system control firm 22 starts to be activated (FIG. 6, S104), and starts to transmit a COMINIT signal to the lower device (S105). The power supply controller 24 stops the OOB detector 23 (S106).

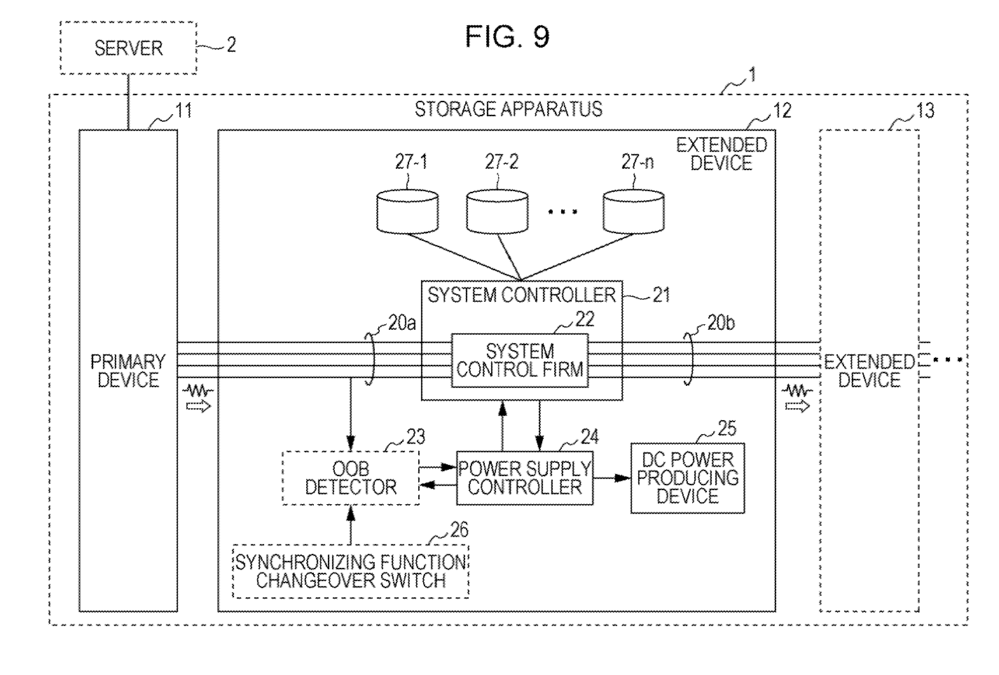

FIG. 9 illustrates the extended device 12 in the operating state. In FIG. 9, components being powered on and working are illustrated by solid frames, and components not working are illustrated by dotted frames. In the operating state, the DC power producing device 25 is activated by the power supply controller 24 and supplies the system controller 21 and the storage media 27-1 through 27-n with power.

The system controller 21 works upon being supplied with power. The system controller 21 runs the system control firm 22. The system control firm 22 starts the OOB sequence, and transmits a COMINIT signal to the lower communication line 20b.

Thus, if the extended device 13 being the lower device is configured similarly as the extended device 12, the extended device 13 can detect the COMINIT signal transmitted by the extended device 12 and be activated from the waiting state.

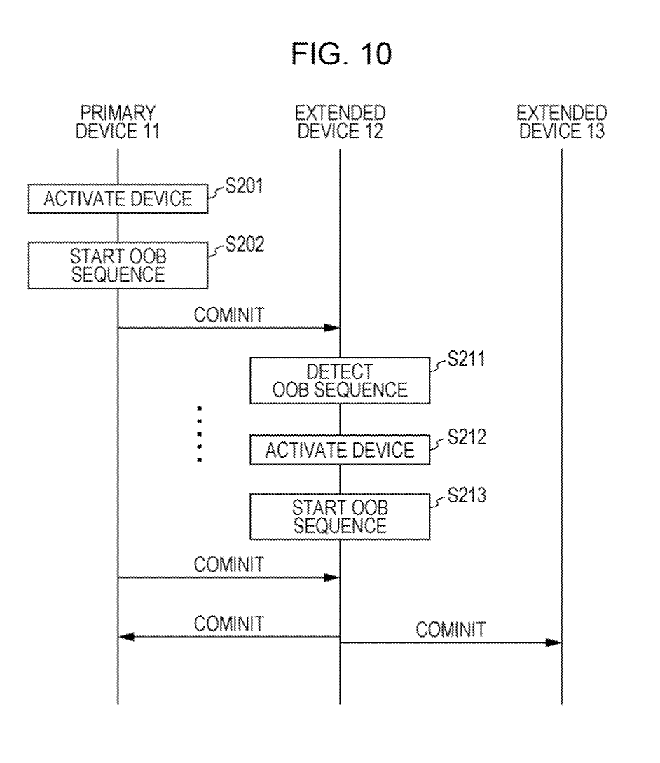

FIG. 10 is a sequence diagram for illustrating power-on synchronization in the storage apparatus 1. The primary device 11 and the extended devices 12 and 13 are waiting in an initial state. The primary device 11 is activated at first as operated by an operator, etc. (S201), and starts the OOB sequence (S202). In the OOB sequence, the primary device 11 transmits a COMINIT signal to the extended device 12. The primary device 11 transmits COMINIT signals repeatedly until the primary device receives a COMINIT signal from the extended device 12.

The extended device 12 detects the COMINIT signal by means of the OOB detector 23 (S211), and activates the own device (S212). After being activated, the extended device 12 starts the OOB sequence (S213), and starts to transmit COMINIT signals to the primary device 11 and to the extended device 13.

Upon receiving the COMINIT signal from the extended device 12, the primary device 11 can shift to a next step in the OOB sequence. Further, upon receiving the COMINIT signal from the extended device 12, the extended device 13 can start to activate the own device.

According the storage apparatus 1 of the second embodiment, as described above, the extended device 12 leaves the system controller 21 not working in the waiting state, and observes the upper communication line 20a by means of the OOB detector 23. Upon detecting a COMINIT signal transmitted by the primary device 11, the OOB detector 23 notifies the power supply controller 24 of the detection so as to activate the system controller 21. The storage apparatus 1 can thereby use a sequence for starting the SAS communication so as to activate the extended device 12 synchronously with the primary device 11 having been activated.

Further, the storage apparatus 1 observes the OOB sequence of the primary device 11 by means of the OOB detector 23 consuming less working power than the system controller 21. The storage apparatus 1 can thereby consume less power than a configuration such that the system controller 21 works in the waiting state so as to implement power-on synchronization.

Further, the extended device carries out the OOB sequence and transmits a COMINIT signal to the lower device when being activated. The storage apparatus 1 can thereby implement the power-on synchronization for the extended device 13 connected in series to the extended device 12 and for the following lower devices, as well.

Further, the extended device 12 can prevent the power consumption for working from increasing by stopping the operation of the OOB detector 23 after being activated. Incidentally, in order that the operation of the OOB detector 23 is stopped, the OOB detector 23 can be supplied with no power, or can stop the operation for observation while being supplied with power. The OOB detector 23 stops the operation after being activated, and then resumes the operation upon the extended device 12 falling in a waiting state next time.

What is claimed is:

1. A storage apparatus comprising:
a storage medium for storing data;
a controller for controlling an access from an upper device to the storage medium through a data line for transmitting data;
a detector for detecting a transition of an access signal for requesting access from the upper device through the data line; and
a power controller for supplying power to the controller in accordance with a rate of the transition of the access signal detected by the detector.

2. The storage apparatus of claim 1, wherein the access signal exceeds a predetermined voltage level for a plurality of times, and the detector detects number of transitions exceeding the predetermined voltage of the access signal in a predetermined interval.

3. The storage apparatus of claim 1, wherein the detector detects a waveform of a signal received from the upper device when the upper device begins to connect with the controller.

4. The storage apparatus of claim 1, wherein the controller communicates with a lower device, and the controller transmits the signal to the lower device when the upper device begins to connect with the controller.

5. The storage apparatus of claim 1, wherein the detector powers off when the controller powers on.

6. A storage system comprising:
a basic apparatus for receiving an access request from an external; and
an extension apparatus connected to the basic apparatus, comprising:
a storage medium for storing data;
a controller for controlling an access from the basic apparatus to the storage medium through a data line for transmitting data;
a detector for detecting a transition of an access signal for requesting access from the basic apparatus through the data line; and
a power controller for supplying power to the controller in accordance with a rate of the transition of the access signal detected by the detector.

7. An activation method of storage apparatus, the storage apparatus including a storage medium for storing data, and a controller for controlling an access from the upper device to the storage medium through a data line for transmitting data, comprising:
checking an access from the upper device through the data line;
detecting a transition of an access signal for requesting access from the upper device through the data line; and
supplying power to the controller in accordance with a rate of the transition of the detected access signal.
